(19) United States
(12) Patent Application Publication
(10) Pub. No.: US 2025/0206216 A1
(43) Pub. Date: Jun. 26, 2025

(54) MODULE SUPPORT ARRANGEMENT

(71) Applicant: Faurecia Autositze GmbH, Hannover (DE)

(72) Inventors: Piotr Ceglarek, Katowice (PL); Tomasz Stasinski, Dzierzoniow (PL); Tomasz Kowalski, Walbrzych (PL); Adrian Malik, Wroclaw (PL); Slawomir Filip, Grabianów (PL)

(73) Assignee: Faurecia Autositze GmbH, Hannover (DE)

(21) Appl. No.: 18/980,457

(22) Filed: Dec. 13, 2024

(30) Foreign Application Priority Data
Dec. 21, 2023 (DE) 102023136234.8

(51) Int. Cl. B60N 2/90; B60N 2/58

(52) U.S. Cl. CPC B60N 2/914; B60N 2/5825; B60N 2/5866; B60N 2/5875

(57) ABSTRACT

A module support arrangement for attachment to the seat structure of a motor vehicle seat and for fixing pneumatic components or non-pneumatic components has a module support with a front side and a rear side opposite the front side. Optionally, the module support arrangement has at least one further component, wherein air ducts and/or air duct sections are integrated in the module support and/or in the at least one further component. At least one pressure accumulator that is in fluidic communication with at least one of the air ducts or air duct sections is integrated on or in the module support and/or on or in the further component.

### CROSS REFERENCE TO RELATED APPLICATIONS

This application claims priority on and the benefit of German patent application number 10 2023 136234.8 having a filing date of 21 Dec. 2023.

### BACKGROUND OF THE INVENTION

### Technical Field

The invention relates to a module support arrangement.

### Prior Art

Such module support arrangements, such as those known from EP 3 845 415 A1, are generally attached to a vehicle seat structure and are designed to fasten certain functional components, such as fluid actuators, valve blocks or pumps to same. In addition, the module support arrangements are also used to fasten the corresponding lines for transporting air to the individual components. As a rule, such module support arrangements are found in vehicle seats behind the seat upholstery of the backrest or seat section.

With the known systems, the functional components usually have to be attached individually to the module support. This requires fastenings for lines, valve blocks, pumps, etc. The number of components required for complete assembly, and therefore the number of components required, is relatively high with this approach. Typically, an air flow is generated in the fluid-carrying components by using a pneumatic pump. This undoubtedly causes the pump to vibrate, whereby interference arises that the vehicle occupant notices. For example, the frequency of the pump is used to modulate signals onto a massage system fed by the pump, which the occupant then feels. These perceived unwanted vibrations, which the employed massage bladders experience during filling or emptying, should be avoided if possible. Typically, an external pressure accumulator is installed at a specific location in a pneumatic system. This usually happens between the pump and a valve block with the aim of stabilizing the air flow through the pneumatic system. However, this measure leads to comparatively higher costs since additional components have to be installed, which incur costs per se, but on the other hand also require additional assembly time.

### BRIEF SUMMARY OF THE INVENTION

The object of the present invention is therefore to create a module support arrangement with which the described disadvantages can be avoided.

This object is achieved by a module support arrangement for attachment to the seat structure of a motor vehicle seat and for fixing pneumatic components or non-pneumatic components, having a module support with a front side and a rear side opposite the front side, and optionally at least one further component, wherein air ducts and/or air duct sections are integrated in the module support and/or in the at least one further component, wherein at least one pressure accumulator in fluidic communication with at least one of the air ducts or air duct sections is integrated on or in the module support and/or on or in the further component, and a vehicle seat having a seat frame structure and a module support arrangement suspended therefrom via a suspension as taught herein. Advantageous embodiments can be found in the dependent claims.

The present invention reduces the number of required components in that parts of the piping system are already integrated in the module support arrangement or the carrier material thereof. It is therefore provided according to the invention that the fluid lines are no longer designed as hoses or the like, but are already integrated in the carrier material of the module support arrangement as air ducts or at least air duct sections. Only one additional component, e.g. a cover, is required to close any channels that may still be open. A complex installation of the fluid hoses is therefore no longer necessary, and the number of components is greatly reduced.

The module support arrangement according to the invention, which is used for attachment to the seat structure of a motor vehicle seat and for fixing pneumatic components or non-pneumatic components, has a module support with a front side and a rear side opposite the front side. Optionally, the module support arrangement has at least one further component. i) Air ducts and/or ii) air duct sections are integrated in the module support and/or in the at least one further component. The latter can be recessed, preferably towards the back side and/or the front side. In the case of alternative i), complete air ducts can be integrated.

According to the invention, at least one pressure accumulator that is in fluidic communication with at least one of the air ducts or air duct sections is integrated on or in the module support and/or on or in the further component.

This design has numerous advantages. On the one hand, existing components are used to form the at least one pressure accumulator. If, for example, air ducts or air duct sections are already integrated in a module support, a corresponding recess in the module support to form a pressure accumulator can be easily also integrated during the same integration process. This design can eliminate the need for additional separate components and therefore also saves additional assembly effort. The same applies to an additional component that is to be installed or has already been installed on the module support, for example a cover for air duct sections, which can be used to at least form part of the pressure accumulator. Especially when the module support is made of a plastic material, for example injection-molded material, corresponding recesses for pressure accumulators can be easily integrated by inserting parts into the injection mold.

According to a preferred embodiment of the module support arrangement according to the invention, it is therefore provided that the at least one pressure accumulator is arranged in the module support and/or the further component. This arrangement can preferably be arranged in the vicinity of a pump which feeds a pneumatic system, which also includes the fluid channels mentioned above, and/or a fluid actuator, for example a fluid-fillable bladder of a massage system and/or adjustment system of motor vehicle seats. In this way, in the proximity of an active pneumatic component, the air flow entering the fluid actuators is stabilized with the help of the pressure accumulator, therefore avoiding vibrations caused by the pump.

In principle, the pressure accumulator can be entirely completed by integration into a module support or another component. However, a preferred embodiment provides that the pressure accumulator is formed from at least two parts which, after being joined, form an airtight chamber. For example, a recess can be formed in the module support which is in fluidic communication with an air duct or air duct section and whose cross section in the flow direction is widened compared to the cross section of the adjoining air duct or air duct section. In principle, different cross-sectional area geometries, viewed perpendicular to the flow direction, are possible. For example, the cross-sectional areas of this cited recess or fluid reservoir, viewed transversely to the flow direction, can accordingly be oval, circular, rectangular or a combination thereof.

Preferably, as indicated above, it is provided that at least part of the pressure accumulator is integrated in an air duct or air duct section. In this way, no artificial connections need to be made between the pressure accumulator and the air-conducting sections of the pneumatic system installed on the module support. Additional connections can therefore be eliminated so that assembly and installation effort can be further reduced.

The pressure accumulator, which is preferably a chamber, can additionally have a silencer device which is introduced into the pressure accumulator preferably before it is completed. For example, a recess can be provided in the module support as part of the pressure accumulator to be manufactured later; a silencer device, for example a foam material or the like, can then be introduced into this recess. The recess is then closed by attaching the additional component, preferably a cover, so that the silencer device is integrated therein.

Preferably in the case of alternative ii), it is preferably provided that air duct sections and/or a part of the pressure accumulator are integrated in the module support and/or the further component in such a way that each of the air duct sections and/or the part of the pressure accumulator comprises open longitudinal sides, wherein the module support or the at least one further component serves as a cover which closes the open longitudinal sides of the air duct sections of the part of the pressure accumulator to form air ducts and/or a pressure accumulator. On the one hand, a plurality of covers can be provided for separately covering air duct sections on the one hand, and the recess formed as part of the pressure accumulator on the other hand; on the other hand, all of the cited components can also be closed by means of a single cover.

Open long sides are created, for example, in that grooves, U-shaped only in cross-section, are introduced in the module support are open to one side, the long side. Preferably, in the case of existing ventilation duct sections with open longitudinal sides, a cover also exists which closes the open longitudinal sides of the air duct sections in such a way that air ducts are thereby created. Air ducts created in this way or already existing are then designed in such a way that air can enter or exit preferably only at the ends located in the direction of flow. Branches or openings between the ends are in principle conceivable. Separate attachment of air lines or hoses can be avoided in this way, saving assembly effort on the one hand and additional components on the other hand since the cover can cover a plurality of air duct sections at the same time. The cover can also be part of a housing which is designed to accommodate another pneumatic component, for example a valve block or a pump. In this way, integration can be increased even further.

The module support and the at least one further component, preferably designed as a cover for air duct sections and/or as part of the pressure accumulator, can be connected, for example, by laser welding, high-frequency welding, vibration welding, gluing or clipping.

It is preferably provided that the module support has a recess in which the integrated air duct sections are arranged. When the additional component, e.g. in the form of a cover, is then inserted into the recess, which is preferably done in a form-fitting manner, the additional component is automatically correctly positioned to close the corresponding open long sides, which further simplifies assembly. Another component or cover can itself by all means be of several parts.

The material of the module support and/or the other component can be designed in different ways. According to preferred embodiments, it can be provided, among other things, that the material comprises or consists of a plastic material, a foil material, or a felt material. The support material or the module support arrangement can be a part formed by injection molding or formed by thermoforming or have such a part.

Other parts can also be integrated into the module support arrangement according to the invention. Preferably, for example, it can be provided that the module support comprises integrated fastening sections for attaching or accommodating pneumatic components and/or non-pneumatic components. The pneumatic components can be selected from the following group, for example: pump, valve block, fluid actuator. For example, a non-pneumatic component can be selected from the group comprising the following: vibration system component, ventilation system component, electrical component, wiring harness, connector, cover. The optional additional component can be a pneumatic or non-pneumatic component.

According to the invention, sections to which hose lines or fluid actuators can be fastened can also be provided on the module support.

The pressure accumulator can be made of the same material, preferably plastic material, as the module support and/or the other component. Alternatively, the pressure accumulator can also comprise other materials. Preferably, such a material is selected from the following group: textile material, preferably nylon or PP, cellulose, open-cell or closed foam material, open-cell insulation material, damping material.

Finally, the invention relates to a vehicle seat that has a seat frame structure and a module support arrangement as described above, which is suspended therefrom via a suspension.

### BRIEF DESCRIPTION OF THE DRAWINGS

The invention will be explained in more detail below with reference to FIGS. 1-5.

FIG. 1 shows a schematic, lateral, exploded view of an embodiment of a module support arrangement according to the invention in sectional view.

FIG. 2 shows the embodiment shown in FIG. 1 as a simple sectional view.

FIG. 3 shows a plan view of the rear side of an example of a module support of a module support arrangement according to the invention.

FIG. 4 shows in a perspective exploded view an example of the design of a pressure accumulator according to the invention.

FIG. 5 shows a plan view of the pressure accumulator shown in FIG. 4 with an additional silencer device.

### DETAILED DESCRIPTION OF PREFERRED EMBODIMENTS

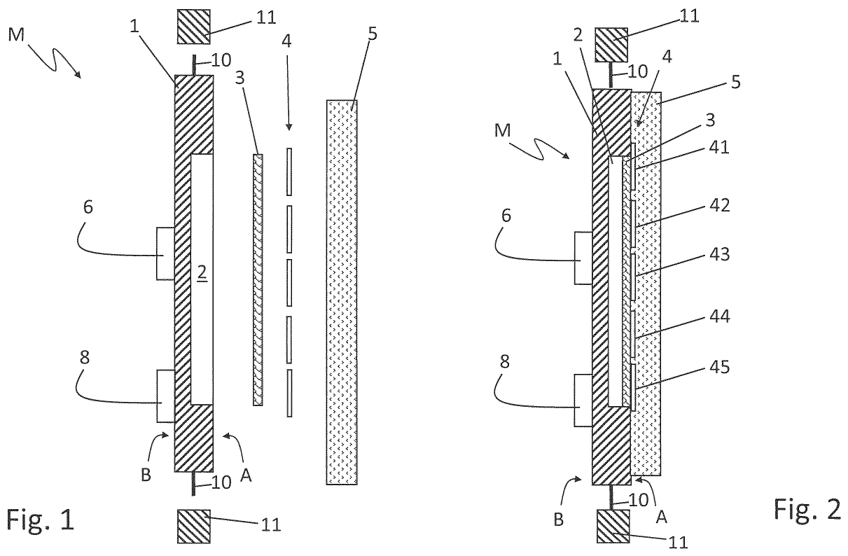

FIGS. 1 and 2 show a sectional view of an exemplary structure of a module support arrangement M according to the invention. In FIG. 1 in exploded view, in FIG. 2 in assembled view.

The module support 1 has a front side A and a rear side B. As a rule, the front side A will point in the direction of travel of a vehicle seat fitted with the module support arrangement M according to the invention. Of such a vehicle seat, only the seat frame structure 11 and a seat cushion 5 are indicated here. The module support 1 can then be attached to the seat frame structure 11 via a suspension 10, which in the simplest case is a metal wire or the like.

The module support 1 is preferably made of a material that preferably contains plastic, a foil, or felt. In a preferred embodiment, a recess 2, which is not absolutely necessary, is arranged in the module support 1, preferably a recess accessible from the front side A. The module support 1 has, preferably in the bottom of the recess, air duct sections (not shown in detail here) or even complete air ducts which are part of a pneumatic system which is installed on the module support 1 as part of the module support arrangement M according to the invention. In addition to a line system that is formed by the air ducts, the pneumatic system can have further components, for example pneumatic components such as a valve block 6 and/or a pump 8.

In the shown example, the module support arrangement M further comprises a further component, here in the form of a cover 3, which can be attached to the module support 1—preferably in a form-fitting manner if a recess 2 is present—in order to cover air duct sections present there and to prevent the air flowing through them from escaping to the outside. If complete air ducts are already present in the module support 1, such a cover is not necessary. However, it is also alternatively or additionally possible to integrate corresponding air duct sections in the additional component 3 mentioned above. The complete air ducts are then also created by joining module support 1 and further component 3. Reference signs 4 and 41-45 designate fluid actuators, which are preferably fluid-fillable bladders, with the aid of which a seat adjustment function or even a massage function can be realized. These fluid actuators 4, 41-45 also form components of the pneumatic system and can be connected to air routing ducts in the module support 1 and/or the further component 3, and therefore supplied with air. A seat cushion 5 can then be attached to the front side A above the fluid actuators 4, 41-45.

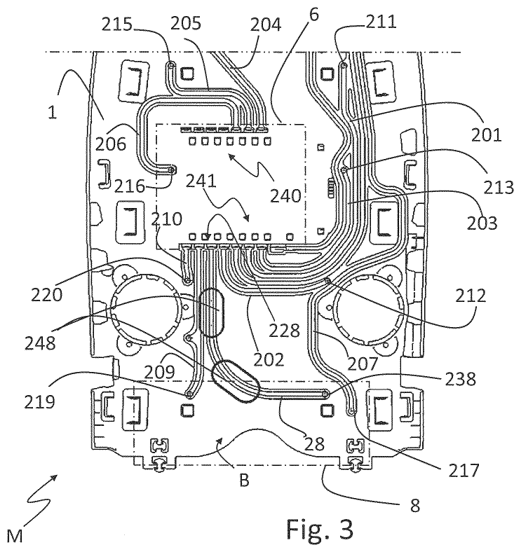

A plan view of the rear side B of the module support arrangement M according to the invention, more precisely of the module support 1 thereof, is shown in FIG. 3. The air duct sections 201-210 which are arranged recessed can be seen. These air duct sections 201-210 have corresponding connections 211-220 at their one end, which serve to connect the fluid actuators described above to the air duct system. The fluid actuators can be connected to these connections 211-220 either directly or, for example, via a short hose.

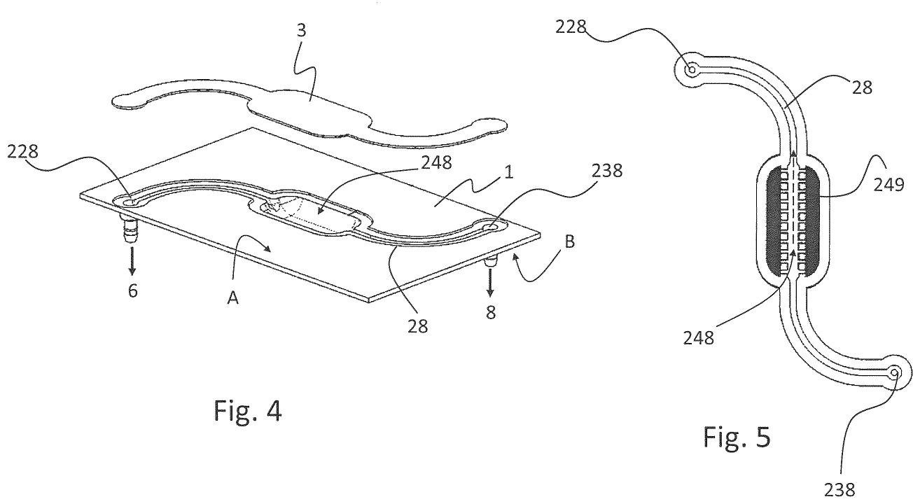

At their other ends, the air duct sections 201-210 are arranged on one of the connection rows 240, 241 for the valve block 6. The valve block 6 is supplied by the pump 8 via the air duct section 28. The inlet valve 228 connects the air duct section 28 to the valve block and supplies it with the fluid, preferably compressed air. The compressed air from the pump 8 into the air duct section 28 is supplied via the pump connection 238. The vibrations and pressure fluctuations of the pump should, if possible, not be transmitted to the valve block and therefore to the rest of the pneumatic system. For this purpose, in this embodiment, two pressure accumulators 248 are integrated into the air duct section 28. These are primarily sections of the air duct section 28 in which the cross-section is greatly enlarged compared to the other air duct sections 28. The function can be explained more clearly in FIG. 4.

FIG. 4 shows a perspective view of an air duct section 28 which is incorporated into the front side A of a module support 1. On the left side, the air duct 28 ends in the inlet valve 228, to which the valve block 6 is connected. At the right end, the air duct section 28 opens into the pump connection 238. The strong widening of the air duct section 28 represents the pressure accumulator 248. The air duct section 28 is closed by the cover 3. A pressure wave arriving from the pump 8 is attenuated by the strong increase in the cross-section in the pressure accumulator 248. Only a part of the pressure wave is transmitted into the subsequent section of the air duct section 28. The rest of the pressure wave substantially reflects in the pressure accumulator 248 and slowly subsides.

FIG. 5 shows the air duct section 28 shown in FIG. 4 in plan view. The version shown in FIG. 5 differs in that a silencer device 249 has been introduced into the pressure accumulator 248. This silencer device 249 attenuates a pressure wave or sound waves in the pressure accumulator even more so that they die down more quickly.

With such a device, the fluid actuators 4, 41-45 work with fewer disruptions and more quietly so that the device as such is perceived as more pleasant for a user during its use.

What is claimed is:

1. A module support arrangement (M) for attachment to the seat structure of a motor vehicle seat and for fixing pneumatic components (6, 8; 41-50) or non-pneumatic components, having a module support (1) with a front side (A) and a rear side (B) opposite the front side (A), and optionally at least one further component (3), wherein
i) air ducts and/or
ii) air duct sections (28, 201-210) are integrated in the module support (1) and/or in the at least one further component (3),
wherein at least one pressure accumulator (248, 249, 3) in fluidic communication with at least one of the air ducts or air duct sections (28, 201-210) is integrated on or in the module support (1) and/or on or in the further component (3).

2. The module support arrangement (M) according to claim 1, wherein the at least one pressure accumulator (248, 3; 249) is arranged in the module support (1) and/or the further component (3), preferably in the vicinity of a pump (8) and/or a fluid actuator.

3. The module support arrangement (M) according to claim 1, wherein the pressure accumulator (248) is formed from at least two parts (248, 3) which, after being joined, form an airtight chamber.

4. The module support arrangement (M) according to claim 1, wherein at least part (248) of the pressure accumulator (248, 3; 249) is integrated in an air duct or air duct section (28).

5. The module support arrangement (M) according to claim 1, wherein the pressure accumulator (248, 3; 249) has a silencer device (249) which is preferably introduced into the pressure accumulator (248, 3; 249) before it is completed.

6. The module support arrangement (M) according to claim 1, wherein air duct sections (28, 201-210) and/or a part (248) of the pressure accumulator are integrated in the module support (1) and/or the further component (3) in such a way that each of the air duct sections (28, 201-210) and/or the part (248) of the pressure accumulator comprises open longitudinal sides, wherein the module support (1) or the at least one further component (3) serves as a cover (3) which closes the open longitudinal sides of the air duct sections (28, 201-210) and/or the part of the pressure accumulator to form air ducts and/or a pressure accumulator.

7. The module support arrangement (M) according to claim 1, wherein the module support (1) and the at least one further component (3), preferably designed as a cover (3) for air duct sections and/or a part (248) of the pressure accumulator, are connected by laser welding, high-frequency welding, vibration welding, gluing or clipping.

8. The module support arrangement (M) according to claim 1, wherein the pressure accumulator (248, 249) is made of the same material, preferably plastic material, as the module support (1) and/or the further component (3), or that the pressure accumulator (248, 249) additionally comprises other materials, preferably selected from the following group: textile material, preferably nylon or PP, cellulose, open-cell or closed foam material, open-cell insulation material, damping material.

9. A vehicle seat having a seat frame structure and a module support arrangement (M) suspended therefrom via a suspension (10) according to claim 1.
